(19) United States
(12) Patent Application Publication
(10) Pub. No.: US 2025/0165699 A1
(43) Pub. Date: May 22, 2025

(54) METHOD AND APPARATUS OF GENERATING MEETING SUMMARY, ELECTRONIC DEVICE AND READABLE STORAGE MEDIUM

(71) Applicant: BOE TECHNOLOGY GROUP CO., LTD., Beijing (CN)

(72) Inventors: Lifei Zhao, Beijing (CN); Jinpeng Wang, Beijing (CN); Chao Zhang, Beijing (CN); Shaoxun Su, Beijing (CN)

(73) Assignee: BOE TECHNOLOGY GROUP CO., LTD., Beijing (CN)

(21) Appl. No.: 18/841,111

(22) PCT Filed: Jan. 10, 2023
(86) PCT No.: PCT/CN2023/071473

§ 371 Date: Aug. 23, 2024

(30) Foreign Application Priority Data
Feb. 25, 2022 (CN) 202210178673.0

(51) Int. Cl. G06F 40/166; G06F 3/16; G06F 40/205; G10L 17/02

(52) U.S. Cl. CPC G06F 40/166; G06F 3/165; G06F 40/205; G10L 17/02

(57) ABSTRACT

The present disclosure provides a method and apparatus of generating a meeting summary, an electronic device and a readable storage medium. The method of generating the meeting summary includes: receiving a generation request for generating a meeting summary of a target meeting, extracting a meeting record file of the target meeting according to the generation request, where the meeting record file includes a meeting audio recording and display data, and the meeting audio recording and the display data are collected through an intelligent meeting interaction device, and parsing the meeting record file to generate the meeting summary of the target meeting, where the meeting summary includes a spoken text generated according to the meeting audio recording and display data, and a time of the display data corresponds to a time of the meeting audio recording.

### CROSS-REFERENCE TO RELATED APPLICATIONS

This application claims priority to Chinese Patent Application No. 202210178673.0 filed in China on Feb. 25, 2022, which is incorporated by reference herein in its entirety.

### TECHNICAL FIELD

Embodiments of the present disclosure relate to the field of computer technologies, in particular to a method and apparatus of generating a meeting summary, an electronic device and a readable storage medium.

### BACKGROUND

Usually, in order to save and record relevant contents in a meeting, it requires to establish a meeting summary of the meeting. In the related art, the meeting summary of the meeting is typically established by recording a meeting content through text and other means.

### SUMMARY

In a first aspect, embodiments of the present disclosure provide a method of generating a meeting summary, including:
receiving a generation request for generating a meeting summary of a target meeting;
extracting a meeting record file of the target meeting according to the generation request, where the meeting record file includes a meeting audio recording and display data, and the meeting audio recording and the display data are collected through an intelligent meeting interaction device; and
parsing the meeting record file to generate the meeting summary of the target meeting, where the meeting summary includes a spoken text generated according to the meeting audio recording and display data, and a time of the display data corresponds to a time of the meeting audio recording.

In some embodiments, the meeting summary includes a plurality of sub-contents, each sub-content includes the spoken text and the display data.

In some embodiments, a time of the display data included in each sub-content corresponds to a time of the spoken text included in the sub-content.

In some embodiments, parsing the meeting record file to generate the meeting summary of the target meeting includes:
identifying a plurality of speaking objects corresponding to the meeting audio recording according to voiceprint information; and forming the plurality of sub-contents according to a speaking order of the speaking objects.

In some embodiments, the meeting summary includes the meeting audio recording, and after forming the plurality of sub-contents according to the speaking order of the speaking objects, the method further includes:
displaying an audio play control identifier and the spoken text corresponding to the sub-content, where the audio play control identifier is configured to control playing the meeting audio recording corresponding to the sub-content, and the spoken text is obtained by identifying the meeting audio recording corresponding to the sub-content; and
displaying at least one data display region in the meeting summary, where the data display region is configured to display the display data of which the time corresponding to the time of the meeting audio recording.

In some embodiments, the display data includes one or more of a screen-recording video and a screenshot image captured by the intelligent meeting interaction device during the target meeting.

In some embodiments, the quantity of the data display regions is multiple, each data display region corresponds to one sub-content, and the data display region configured to play a screen-recording video corresponding to the sub-content or display a screenshot image corresponding to the sub-content.

In some embodiments, after parsing the meeting record file to generate the meeting summary of the target meeting, the method further includes: receiving a control request for a target control identifier among audio play control identifiers;
playing a target meeting audio recording corresponding to the target control identifier according to the control request; and
synchronously displaying the display data in the data display region according to a correspondence between the time of the display data and a time of the target meeting audio recording.

In some embodiments, the display data includes a screenshot image at an end time of a speaking time of a corresponding speaking object in the meeting audio recording or at a preset time after the speaking time is ended.

In some embodiments, the display data includes the screen-recording video, and extracting the meeting record file of the target meeting according to the generation request includes:
determining a speaking time of each speaking object according to a recognition result of the speaking object in the meeting audio recording; and
determining the screen-recording video corresponding to the speaking time according to the speaking time.

In some embodiments, the display data includes display data of an operation region determined according to the speaking time.

In some embodiments, the method further includes: obtaining the display data of the operation region determined according to the speaking time;
obtaining the display data of the operation region determined according to the speaking time includes:
determining a target operation record corresponding to the speaking time;
identifying an operation region corresponding to a position where the target operation record is located; and
determining the display data corresponding to the speaking time according to the operation region corresponding to the position where the target operation record is located.

In some embodiments, the target operation record includes an operation record of a writing operation.

In some embodiments, determining the screen-recording video corresponding to the speaking time according to the speaking time includes:
determining an operation time corresponding to the speaking time, where the operation time covers the speaking time;
determining the screen-recording video corresponding to the speaking time according to the operation time.

In some embodiments, the operation time includes the speaking time, and the operation time further includes at least one of a first time period or a second time period, where the first time period is a time period of a first preset duration before the speaking time, and the second time period is a time period of a second preset duration after the speaking time.

In some embodiments, the meeting record file further includes a live video file of the target meeting, and the meeting summary further includes a live video clip corresponding in time to the meeting audio recording.

In some embodiments, the meeting record file is stored in hyper text markup language html format.

In a second aspect, the embodiments of the present disclosure further provide an apparatus of generating meeting summary, applied to an intelligent meeting interaction device, including:
a generation request receiving module, configured to receive a generation request for generating a meeting summary of a target meeting;
an extraction module, configured to extract a meeting record file of the target meeting according to the generation request, where the meeting record file includes a meeting audio recording and display data of the intelligent meeting interaction device; and
a generation module, configured to parse the meeting record file to generate the meeting summary of the target meeting, where the meeting summary includes a spoken text generated according to the meeting audio recording and display data corresponding in time to the meeting audio recording.

In a third aspect, the embodiments of the present disclosure further provide an electronic device including: a memory, a processor, and a program stored on the memory and executable on the processor, the processor is configured to read the program in the memory to implement steps of the method as described in the first aspect.

In some embodiments, the electronic device is the intelligent meeting interaction device, and the intelligent meeting interaction device includes a microphone, and the microphone is configured to capture the meeting audio recording.

In a fourth aspect, the embodiments of the present disclosure further provide a readable storage medium having a program stored thereon, the program, when executed by a processor, performs steps of the method as described in the first aspect.

### BRIEF DESCRIPTION OF THE DRAWINGS

In order to illustrate the technical solutions of the embodiments of the present disclosure in a clearer manner, the drawings required for the description of the embodiments of the present disclosure will be described hereinafter briefly. Apparently, the following drawings merely relate to some embodiments of the present disclosure, and based on these drawings, a person of ordinary skill in the art may obtain other drawings without any creative effort. In these drawings,

FIG. 1 is a flowchart of a method of generating a meeting summary according to one embodiment of the present disclosure;

FIG. 2 is a schematic view showing a display interface according to one embodiment of the present disclosure;

FIG. 3 is another schematic view showing the display interface according to one embodiment of the present disclosure;

FIG. 4 is a schematic diagram illustrating a format of meeting summary according to one embodiment of the present disclosure:

FIG. 5 is a schematic flowchart of determining an operation region according to one embodiment of the present disclosure;

FIG. 6 is a schematic structural diagram of an apparatus of generating a meeting summary according to one embodiment of the present disclosure;

FIG. 7 is a block diagram of an electronic device according to one embodiment of the present disclosure.

### DETAILED DESCRIPTION

The technical solutions in the embodiments of the present disclosure will be described hereinafter clearly with reference to the drawings of the embodiments of the present disclosure. Apparently, the following embodiments merely relate to a part of, rather than all of, the embodiments of the present disclosure, and based on these embodiments, a person of ordinary skill in the art may, without any creative effort, obtain other embodiments, which also fall within the scope of the present disclosure.

Terms such as “first” and “second” in the specification and the claims of the present disclosure are used to distinguish similar objects and are not necessarily used to describe a specific order or sequence. In addition, terms such as “including” and “having” and any variations thereof are intended to cover non-exclusive inclusion. For example, a process, method, system, product or device including a series of steps or units is not limited to the steps or units that are clearly listed and may include other steps or units that are not clearly listed or are inherent to the process, method, product, or device. Moreover, the term “and/or” used in the specification and the claims indicates involving at least one of connected objects, for example, A and/or B and/or C means 7 situations, including: A alone, B alone, C alone, both A and B, both B and C, both A and C, and all of A, B and C.

Embodiments of the present disclosure provide a method of generating a meeting summary.

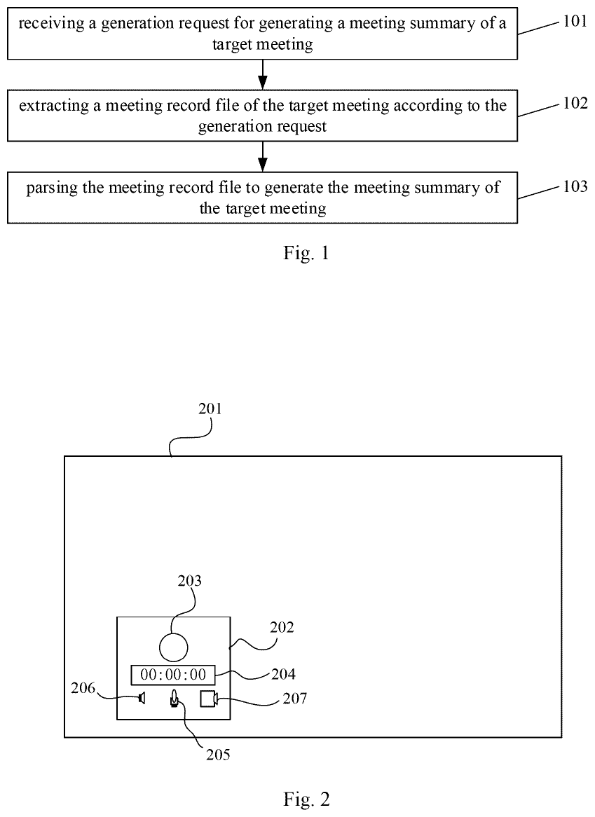

As shown in FIG. 1, in some of the embodiments, the method of generating the meeting summary includes following steps.

Step 101, receiving a generation request for generating a meeting summary of a target meeting.

A user may issue the generation request for the meeting summary in different manners, for example, the user may issue the generation request by actively clicking a corresponding generation control button. Alternatively, the meeting summary may be preset to be automatically generated after the meeting ends, so that the generation request is automatically generated after the meeting ends.

Step 102, extracting a meeting record file of the target meeting according to the generation request.

In the embodiment of the present disclosure, a meeting record file is collected via an intelligent meeting interaction device, and the intelligent meeting interaction device typically refers to an intelligent interaction tablet, and a user may display a presentation document based on the meeting interaction device, and use the meeting interaction device as a handwritten whiteboard to write a content, etc. thereon during a meeting.

After receiving the generation request, the meeting record file required for generating the meeting summary is extracted, and in the embodiment of the present disclosure, the meeting record file includes a meeting audio recording and display data of the intelligent meeting interaction device.

At the beginning of a meeting, a user may open a screen-recording tool on the intelligent meeting interaction device to record a content displayed on the intelligent meeting interaction device during the meeting.

As shown in FIG. 2, in the embodiment of the present disclosure, a screen-recording control 202 is displayed on a display interface 201 of the intelligent meeting interaction device, the screen recording control 202 includes a screen-recording control button 203 for starting and stopping screen-recording operations, and a time box 204 for recording a screen-recording time.

The meeting audio recording specifically includes a live audio recording spoken by an on-site person of the meeting, and may further include a sound of a file played by the intelligent meeting interaction device, and in the embodiment of the present disclosure, this is referred to as an on-screen sound. During the implementation, the live audio recording may be collected by a microphone, and the on-screen sound may also be obtained by reading playing data of a speaker, so as to reduce the interference of an external sound on the on-screen sound.

During the implementation, a live recording switch 205 corresponding to the live audio recording and an on-screen sound switch 206 corresponding to the on-screen sound may be provided on the screen-recording control 202, so that a staff may control the desired sound to be recorded according to needs.

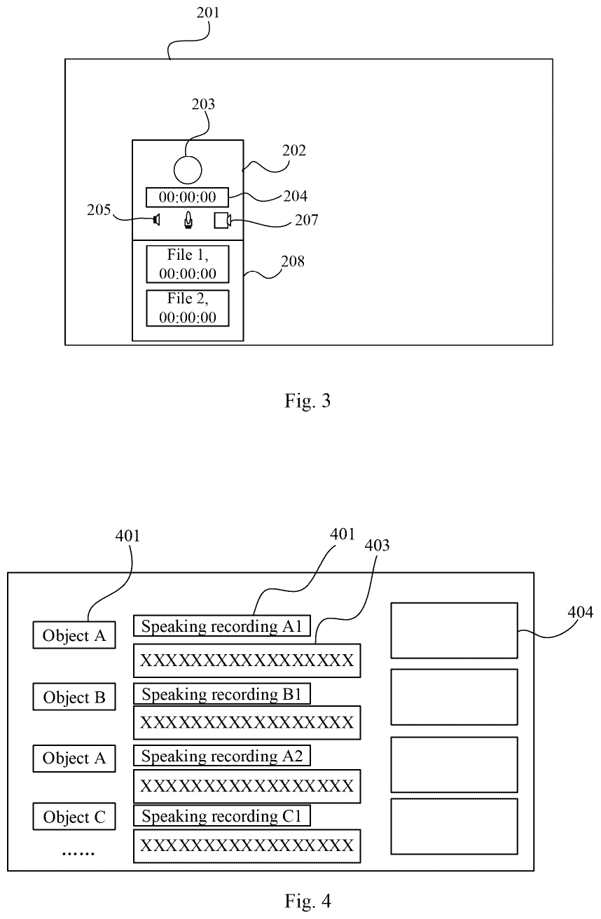

As shown in FIG. 3, the recorded files may be displayed in a recording list 208, and during the implementation, the files may be named according to the time of recording, and may also be named according to the sequential numbering of file 1, file 2. For each file, further operations such as saving, accessing, deleting, format conversion, etc. may be performed.

In some embodiments, the live audio recording and the on-screen sound may be saved in different files. In some embodiments, considering that the intelligent meeting interaction device is likely not to be used to play the content when a participant speaks, and when the intelligent meeting interaction device plays the content, the participant is likely to watch the played content without speaking, therefore, the live audio recording and the on-screen sound may also be recorded and stored in a same audio file.

The display data may be video data, and may also be image data. Specifically, the display data may be a screen-recording video obtained by recording a display interface of the intelligent meeting interaction device in the process of the target meeting, and may also be a screenshot image obtained by taking a screenshot of a display interface of the intelligent meeting interaction device in the process of the target meeting.

The obtained meeting audio recording and display data may be saved in a designated path after format conversion, for example, the recorded files may be named and saved at the recording time, or the recorded files can be named and saved by using serial numbers in chronological order.

During the implementation, different formats may be selected to save the obtained meeting audio recording and display data according to needs. For example, the meeting audio recording may be saved in mp3 format, and the display data may be saved in such different formats as mov, mp4 and wmv, and a resolution of the display data and a quality of the meeting audio recording may also be selected according to needs, which are not further limited herein.

The saved files may be combined, and saved in different formats, e.g., may be saved in html (Hyper Text Markup Language) format, etc.

After receiving the generation request, the meeting audio recording and display data may be extracted in a specified file directory.

Step 103, parsing the meeting record file to generate the meeting summary of the target meeting.

After obtaining the meeting audio recording and display data, the meeting summary of the target meeting is further generated.

It should be appreciated that, in the technical solution of the embodiment of the present disclosure, the meeting summary may be performed on a terminal, for example, may be performed on the intelligent meeting interaction device or any other control device. In the case where the meeting summary is performed on the intelligent meeting interaction device, the meeting record file stored locally in the intelligent meeting interaction device may be directly extracted.

In the case where the meeting summary is performed on any other terminal device, the meeting record file on the intelligent meeting interaction device may be transmitted to the terminal device.

Furthermore, the method may also be performed on a cloud server, and by way of example, a terminal device may send the above-mentioned generation request to the cloud server, and the intelligent meeting interaction device uploads the meeting record file to the cloud server, where the meeting record file is parsed at the cloud server to generate meeting summary.

In the embodiment of the present disclosure, the meeting summary includes a spoken text generated from the meeting audio recording and display data, where a time of display data corresponds to a time of the meeting audio recording.

It can be understood that, in the technical solution of the present embodiment, the above-mentioned obtained meeting audio recording is identified, so as to obtain the spoken text corresponding to the meeting audio recording.

In the embodiment of the present disclosure, the display data corresponding to the time of each meeting audio recording is also captured, that is, the obtained display data corresponding to each meeting audio recording is the display data on the intelligent meeting interaction device when a corresponding speaking object speaks. Thus, meeting summary that includes the spoken text as well as the display data is generated in the embodiment of the present disclosure.

Therefore, it is able for the meeting summary obtained in the technical solution of the embodiment of the present disclosure to restore the meeting content in a more comprehensive manner, thereby to improve the accuracy and completeness of the meeting content recorded through the generated meeting summary.

The generated meeting summary may also be saved in html format, so as to improve compatibility and facilitate access and viewing on different platforms.

In other embodiments, different management operations may be further performed on the meeting summary, for example, the speaking object corresponding to the meeting audio recording may be identified, the meeting audio recording or spoken text of a particular object may be extracted as needed, etc.

In some embodiments, step 103 includes:
identifying a plurality of speaking objects corresponding to the meeting audio recording according to voiceprint information; and
forming the plurality of sub-contents according to a speaking order of the speaking objects.

In the embodiment of the present disclosure, after the meeting audio recording is obtained, the speaking objects in the meeting audio recording is obtained based on voiceprint recognition. The voiceprint recognition technique itself may refer to the related art and is not further defined and described herein.

During the implementation, a sound of each participant may be recorded to extract voiceprint information thereof, and the speaking objects in the meeting audio recording are identified according to the extracted voiceprint information. Different speaking objects may also be manually marked and distinguished after distinguishing the speaking objects according to voiceprint differences.

After recognizing the speaking objects based on the voiceprint information, the plurality of sub-contents are formed based on the speaking order of the speaking object.

In the embodiment of the present disclosure, the meeting summary includes multiple sub-contents, each sub-content including the spoken text and the display data. As can be appreciated, each sub-content corresponds to one speaking. During the implemented, multiple sub-contents may be sequentially displayed in the speaking order.

In order to distinguish the speaking objects corresponding to the sub-contents, an object identifier corresponding to the speaking object may be displayed at each sub-content, the object identifier may be an avatar, a photograph, a name or code or number, etc. of the speaking object, and the object identifiers are sequentially displayed in the speaking order.

As shown in FIG. 4, for example, object A speaks first, and one object identifier 401 corresponding to object A is displayed, so that a sub-content is formed. Next, object B speaks, and another one object identifier 401 corresponding to object B is displayed, so that another sub-content is formed. Object A speaks again, and yet another one object identifier 401 corresponding to object A is displayed to form yet another sub-content, and so on.

In other words, every time there is one speaking, one sub-content is formed, the quantity of sub-contents corresponding to each speaking object may be multiple, and the quantity of sub-contents corresponding to each speaking object is equal to the quantity of speaking times of the speaking object. Here, the definition of one speaking is that no other speaking object speaks during the speaking process, and a pause interval during the speaking process is less than a certain time length, for example, it may be set to be less than 1 minute, less than 40 seconds, or etc.

In some embodiments, the method further includes: displaying an audio play control identifier and the spoken text corresponding to each sub-content, where the audio play control identifier is configured to control playing the meeting audio recording corresponding to the sub-content, and the spoken text is obtained by identifying the meeting audio recording and displaying at least one data display region in the meeting summary, where the data display region is configured to display the display data corresponding to the time of the meeting audio recording.

Still referring to FIG. 4, at a position corresponding to the object identifier 401 of each sub-content, an audio play control identifier 402 is also displayed, and the audio play control identifier 402 is configured to control playing the corresponding meeting audio recording, that is, when a user controls a specific audio play control identifier 402 in meeting summary, the corresponding meeting audio recording is played, so as to directly know a speaking state of the speaking object.

Still referring to FIG. 4, at the position corresponding to each object identifier 401, a corresponding spoken text 403 is also displayed, and based on the spoken text 403, it is able to directly learn the speaking content via the text when it is inconvenient to play the meeting audio recording, so as to enrich the comprehensiveness of obtaining the content of meeting summary.

As shown in FIG. 3, a data display region 404 is also displayed in the meeting summary of this embodiment. The data display region 404 is configured to, when playing the meeting audio recording, play a screen-recording video corresponding to the sub-content or display a screenshot image corresponding to the sub-content.

The played screen-recording video may be understood as a display data segment of an entire display data, and the display data segment is the display data within the time period corresponding to the meeting audio recording. In this way, a correspondence between the content displayed on the intelligent meeting interaction device and the meeting audio recording may be established, and when a user browses the meeting summary and listens to the meeting audio recording, the user may also understand the content displayed on the intelligent meeting interaction device during this time period, thereby facilitating a more accurate and clear understanding of the meeting content.

The screenshot image may be set as required, for example, in a case where the content displayed on the display interface does not change during the speaking process of a speaking object, a screenshot image may be captured, so as to save the storage space occupied by the meeting record file and the meeting summary. In some embodiments, the display data specifically includes a screenshot image at an end time of a speaking time of the speaking object in the meeting audio recording or at a preset time after the speaking time is ended.

In some embodiments, the quantity of data display regions 404 is one, and the display data segments corresponding to the object identifiers 401 are played in the data display region 404.

In some embodiments, the quantity of the data display regions 404 is multiple, each data display region 404 corresponds to one sub-content, and each data display region 404 is used to display the display data corresponding to the sub-content.

In some embodiments, after step 103, the method further includes: receiving a control request for a target control identifier among audio play control identifiers;
playing a target meeting audio recording corresponding to the target control identifier according to the control request; and
synchronously displaying the display data in the data display region according to a correspondence between the time of the display data and a time of the target meeting audio recording.

In the technical solution of the embodiment of the present disclosure, when a user controls to play a certain meeting audio recording in the meeting summary, a corresponding display data segment or an captured screenshot image is synchronously played in the data display region, so as to fully restore a meeting scene, thereby ensuring that other objects can fully and completely restore and understand the meeting content according to the meeting summary.

In some embodiments, the display data may be recordings of the entire display interface of the intelligent meeting interaction device, and in other embodiments, it may be recordings of part of the display interface of the intelligent meeting interaction device.

Specifically, the display data includes display data of an operation region determined according to the speaking time.

Illustratively, in the case where the display data includes the screenshot image, a screenshot range may be determined according to a region corresponding to an operation input during the speaking time, so as to capture an image of the corresponding region.

In the case where the display data includes the screen-recording video, a screen-recording range may be determined according to a region corresponding to the operation input during the speaking time, so as to obtain the screen-recording video within the range.

In some embodiments, extracting the meeting record file of the target meeting according to the generation request includes:
determining a speaking time of each speaking object according to a recognition result of the speaking object in the meeting audio recording; and
determining the screen-recording video corresponding to the speaking time according to the speaking time.

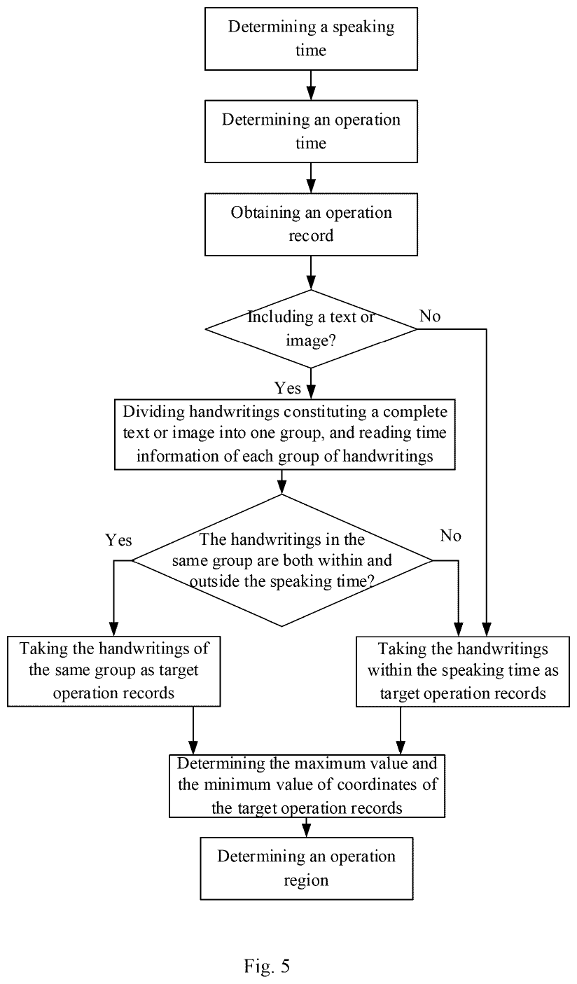

As shown in FIG. 5, in the technical solution of the embodiment of the present disclosure, the speaking time of one speaking object is determined, where the speaking time may be determined through the recognition result of the meeting audio recording. Based on the determined speaking time, display data corresponding to the speaking time is further determined.

In some embodiments, the step of determining the screen-recording video corresponding to the speaking time according to the speaking time specifically includes:
determining an operation time corresponding to the speaking time, where the operation time covers the speaking time;
determining the screen-recording video corresponding to the speaking time according to the operation time.

In some embodiments, the operation input includes an operation input of a writing operation. It should be appreciated that the intelligent meeting interaction device may be used as a writing tablet, and some content may be written on the intelligent meeting interaction device when the speaking object speaks, whereas the speaking object may also write some content first and then speak in conjunction with the written content. Therefore, a time length of the screen-recording video corresponding to the speaking time may be greater than the length of the speaking time. In the embodiment of the present disclosure, the operation time is defined as the time covered by the operation input corresponding to the speaking time. During the implementation, the operation time is determined according to the speaking time, so that the possibility of missing the display data corresponding to the speaking time can be reduced.

In some embodiments, the operation time includes the speaking time, and the operation time further includes at least one of a first time period or a second time period, where the first time period is a time period of a first preset duration before the speaking time, and the second time period is a time period of a second preset duration after the speaking time.

Accordingly, in the embodiment of the present disclosure, the operation time is determined according to the speaking time, the operation time includes the speaking time, and it may be understood that the operation time includes the whole speaking time, and the operation time may further include some time periods which do not belong to the speaking time.

Illustratively, the first preset duration may be 30 seconds, and the operation time may include the speaking time and the first time period, where the first time period is 30 seconds before the speaking time. For another example, the second preset duration is 10 seconds, the operation time includes the speaking time and the second time period, where the second time period is 10 seconds after the speaking time.

Apparently, the operation time may also include the speaking time as well as both the first time period and the second time period, so as to ensure that the relevant content written by the speaking object can be covered by the operation time. Apparently, the lengths of the first preset duration and the second preset duration are not limited thereto, and may be set as required.

In some embodiments, the method further includes a step of obtaining display data of the operation region determined according to the speaking time, and the step specifically includes:
determining a target operation record corresponding to the speaking time;
identifying an operation region corresponding to a position where the target operation record is located; and
determining the display data corresponding to the speaking time according to the operation region corresponding to the position where the target operation record is located.

In the embodiment of the present disclosure, the target operation record associated with the speaking time is identified, and after the target operation record is identified, the operation region is further determined according to the target operation record. Illustratively, the maximum value and the minimum value of coordinates of an operation position corresponding to all target operation records in the horizontal direction and the vertical direction may be determined, and the above-mentioned maximum value and minimum value may be determined according to an existing calculation method, for example, by using Bubble sort, etc., which is not further limited herein.

Having determined the maximum and minimum values of the coordinates in the horizontal and vertical directions, it is able to determine a rectangular region, abscissae of each of two edges of which are respectively the maximum and minimum values in the horizontal direction and the ordinates of each of two edges of which are respectively the maximum and minimum values in the vertical direction. Thus, the operations performed by the user during the time period corresponding to the meeting audio recording are all within the operation region. By displaying only the image of the operation region in the video playing region, the content written by the speaking object may be displayed more clearly, so that the meeting state is understood and restored more clearly.

After the operation region is determined, a screen-recording video or a screenshot image of the operation region is further extracted as the display data of the operation region.

In some embodiments, the corresponding range of the obtained display data may be slightly greater than the determined range of the operation region, and by way of example, it may be set that a size of each side of the display region is greater than a size of the operation region by 5 mm, which is equivalent to adding a frame region to the operation region, thereby enabling the obtained screen-recording video or screenshot image to be more beautiful and improving the user experience.

It should be appreciated that the determined operation region is not necessarily limited to be of a rectangular shape, and may have different shapes such as an oval shape, a circular shape, as long as the entire region corresponding to the target operation region can be covered.

In some embodiments, determining the target operation record corresponding to the speaking time according to the operation time includes:
identifying the target operation record corresponding to the meeting audio recording according to an association between a first operation record and a second operation record, where the first operation record is an operation record within the operation time, the second operation record is an operation record within the speaking time, and the operation time covers the speaking time.

The target operation record is determined in this embodiment through the association between the first operation record and the second operation record.

Specifically, after the operation time is determined, the corresponding operation record within the operation time is identified, for example, the corresponding handwritings within the operation time may be read from a workstation, and the read handwritings may be identified, so as to distinguish whether the handwritings within the operation time include a complete text or image.

In a case where the handwritings include the complete text or image, the handwritings constituting the complete text or image are divided into one group, and time information of each group of handwritings is read, so as to determine whether the handwritings in each group exist only in the speaking time or in both the speaking time and the operation time.

In a case where the handwritings in each group exist in the speaking time, but a part of handwritings outside the speaking time may constitute a complete text or image with a part of the handwritings within the speaking time, it is considered that the user writes the content before speaking. Therefore, it is considered that the content corresponding to the part of the operation record is relevant to the speaking of the user, and the part of the operation record is taken as the target operation record.

In addition, all the operation records within the speaking time are taken as target operation records. In a case where a complete text or image is not formed, only the operation record during the speaking time is taken as the target operation record.

In some embodiments, the meeting record file further includes a live video file of the target meeting and the meeting summary further includes a live video clip corresponding in time to the audio file.

In the embodiment of the present disclosure, the intelligent meeting interaction device may have a built-in camera or an external camera connected thereto, so as to capture a live video of a meeting scene via the camera and saves the same as a live video file. Furthermore, when generating the meeting summary, a live video clip corresponding to the audio file in time may also be added in the meeting summary, so that the meeting scene state may be clearly and completely restored via the meeting summary.

As shown in FIG. 2, on the screen-recording control 202, a recording control switch 207 for controlling the camera to record the live video may be displayed, so as to collect the live video of the meeting scene as required. During the meeting live and video playback, a video window may also be displayed on the display interface 201, so as to display the live video through the video window.

The embodiments of the present disclosure further provide an apparatus of generating meeting summary applied to the intelligent meeting interaction device.

As shown in FIG. 6, in one embodiment, the apparatus 600 of generating the meeting summary includes:
a generation request receiving module 601, configured to receive a generation request for generating a meeting summary of a target meeting;
an extraction module 602, configured to extract a meeting record file of the target meeting according to the generation request, where the meeting record file includes a meeting audio recording and display data, and the meeting audio recording and the display data are collected by the intelligent meeting interaction device; and
a generation module 603 configured to parse the meeting record file to generate the meeting summary of the target meeting, where the meeting summary includes a spoken text generated according to the meeting audio recording and display data, where a time of the display data corresponds to a time of the meeting audio recording.

In some embodiments, the meeting summary includes a plurality of sub-contents, each sub-content includes the spoken text and the display data.

In some embodiments, a time of the display data included in each sub-content corresponds to a time of the spoken text included in the sub-content.

In some embodiments, the generation module 603 includes:
a speaking object identification sub-module, configured to identify a plurality of speaking objects corresponding to the meeting audio recording according to voiceprint information; and
a sub-content generation sub-module, configured to form the plurality of sub-contents according to a speaking order of the speaking objects.

In some embodiments, the meeting summary includes the meeting audio recording, the apparatus further includes:
an identifier display module configured to display an audio play control identifier and the spoken text corresponding to each sub-content, where the audio play control identifier is configured to control playing the meeting audio recording corresponding to the sub-content, and the spoken text is obtained by identifying the meeting audio recording corresponding to the sub-content; and
a region display module configured to display a data display region in the meeting summary, where the data display region is configured to display the display data of which the time corresponding to the time of the meeting audio recording.

In some embodiments, the display data includes one or more of a screen-recording video and a screenshot image captured by the intelligent meeting interaction device during the target meeting.

In some embodiments, the quantity of the data display regions is multiple, each data display region corresponds to one sub-content, and the data display region is configured to play a screen-recording video corresponding to the sub-content or display a screenshot image corresponding to the sub-content.

In some embodiments, the apparatus further includes:
a control request receiving module configured to receive a control request for a target control identifier among audio play control identifiers;
a recording playing module configured to play a target meeting audio recording corresponding to the target control identifier according to the control request; and
a display data displaying module configured to synchronously display the display data in the data display region according to a correspondence between the time of the display data and a time of the target meeting audio recording.

In some embodiments, the display data includes a screenshot image at an end time of a speaking time of a corresponding speaking object in the meeting audio recording or at a preset time after the speaking time is ended.

In some embodiments, the display data includes the screen-recording video, and the extraction module 602 includes:
a speaking time determination sub-module configured to determine a speaking time of each speaking object according to a recognition result of the speaking object in the meeting audio recording; and
a display data determination sub-module configured to determine the screen-recording video corresponding to the speaking time according to the speaking time.

In some embodiments, the display data includes display data of an operation region determined according to the speaking time.

In some embodiments, the apparatus further includes: a display data obtaining module configured to obtain the display data of the operation region determined according to the speaking time;
the display data obtaining module includes:
a target operation record determination sub-module configured to determine a target operation record corresponding to the speaking time;
an operation region identification sub-module configured to identify an operation region corresponding to a position where the target operation record is located; and
a display data determination sub-module configured to determine display data corresponding to the speaking time according to the operation region corresponding to the position where the target operation record is located.

In some embodiments, the target operation record includes an operation record of a writing operation.

In some embodiments, the display data determination sub-module includes:
an operation time determination unit configured to determine an operation time corresponding to the speaking time, where the operation time covers the speaking time; and
a display data determination unit configured to determine the screen-recording video corresponding to the speaking time according to the operation time.

In some embodiments, the operation time includes the speaking time, and the operation time further includes at least one of a first time period or a second time period, where the first time period is a time period of a first preset duration before the speaking time, and the second time period is a time period of a second preset duration after the speaking time.

In some embodiments, the meeting record file further includes a live video file of the target meeting, and the meeting summary further includes a live video clip corresponding in time to the meeting audio recording.

In some embodiments, a format of the meeting record file is hyper text markup language html format. The apparatus 600 of generating the meeting summary in the embodiment of the present disclosure can implement various steps of the embodiments of the method of generating the meeting summary and can achieve substantially the same technical effects, which will not be reiterated in detail herein.

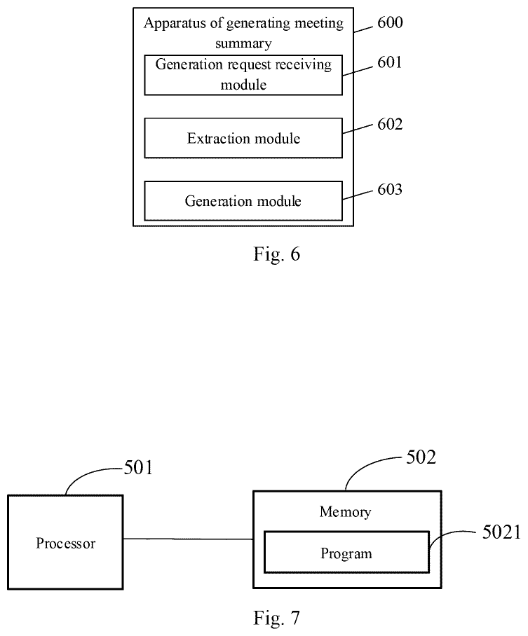

Embodiments of the present disclosure further provide an electronic device. Referring to FIG. 7, the electronic device may include a processor 701, a memory 702, and a program 7021 stored on the memory 702 and executable on the processor 701. The program 7021, when executed by the processor 701, implements any of the steps of the method embodiments described above and achieves the same benefits, which are not reiterated in detail herein.

In some embodiments, the electronic device is specifically the intelligent meeting interaction device, and a microphone is provided on the intelligent meeting interaction device, so as to collect the meeting audio recording. The collected meeting audio recording and display data collected by the intelligent meeting interaction device form the meeting record file, and the meeting summary is further generated through parsing the meeting record file.

Those skilled in the art may appreciate that all or a portion of the steps for implementing the methods of the embodiments described above may be performed by hardware associated with program instructions which may be stored on a readable medium.

The embodiments of the present disclosure further provide a readable storage medium having a computer program stored thereon, the computer program, when executed by a processor, implements any of the steps of the above-mentioned method embodiments and achieve the same technical effects, which are not reiterated herein in order to avoid repetition.

The storage medium may be such as Read-Only Memory (ROM), random Access Memory (RAM), magnetic disk or optical disk, etc.

It should be noted that the above division of various modules is only a division of logical functions, which may be fully or partially integrated into a physical entity or physically separated in actual implementations. These modules may all be implemented in the form of software called by processing elements; or may all be implemented in the form of hardware; or, some modules may be implemented in the form of software called by processing elements, and some modules may be implemented in the form of hardware. For example, the determination module may be a separate processing element, or may be integrated into a certain chip of the above device, or, may be stored in the memory of the above device in the form of program code, and a certain processing element of the above device may call and execute the functions of the determination. Other modules have similar implementations. In addition, all or part of these modules may be integrated together, and may be implemented independently. The processing element mentioned here may be an integrated circuit with signal processing capability. In the implementation process, the various steps of the above method or the above various modules may be implemented by an integrated logic circuit in hardware form in elements of a processor or instructions in the form of software.

For example, the various modules, units, sub-units, or sub-modules may be one or more integrated circuits configured to implement the above methods, such as: one or more application specific integrated circuits (Application Specific Integrated Circuit, ASIC), or, one or more microprocessors (digital signal processor, DSP), or, one or more field programmable gate arrays (Field Programmable Gate Array, FPGA), etc. As another example, when the above module is implemented in the form of a processing element that schedules program codes, the processing element may be a general-purpose processor, such as a central processing unit (Central Processing Unit, CPU) or any other processor that may call program codes. As another example, the modules may be integrated together and implemented as a system-on-a-chip (SOC).

The above embodiments are optional embodiments of the present disclosure, it should be appreciated that those skilled in the art may make various improvements and modifications without departing from the principle of the present disclosure, and theses improvement and modifications shall fall within the scope of the present disclosure.

1. A method of generating a meeting summary, comprising:
receiving a generation request for generating a meeting summary of a target meeting;
extracting a meeting record file of the target meeting according to the generation request, wherein the meeting record file comprises a meeting audio recording and display data, and the meeting audio recording and the display data are collected through an intelligent meeting interaction device; and
parsing the meeting record file to generate the meeting summary of the target meeting, wherein the meeting summary comprises a spoken text generated according to the meeting audio recording and the display data, and a time of the display data corresponds to a time of the meeting audio recording.

2. The method according to claim 1, wherein the meeting summary comprises a plurality of sub-contents, each sub-content comprises the spoken text and the display data.

3. The method according to claim 2, wherein a time of the display data comprised in each sub-content corresponds to a time of the spoken text comprised in the sub-content.

4. The method according to claim 2, wherein parsing the meeting record file to generate the meeting summary of the target meeting comprises:
identifying a plurality of speaking objects corresponding to the meeting audio recording according to voiceprint information; and
forming the plurality of sub-contents according to a speaking order of the speaking objects.

5. The method according to claim 4, wherein the meeting summary comprise the meeting audio recording, and after forming the plurality of sub-contents according to the speaking order of the speaking objects, the method further comprises:
displaying an audio play control identifier and the spoken text corresponding to each sub-content, wherein the audio play control identifier is configured to control playing the meeting audio recording corresponding to the sub-content, and the spoken text is obtained by identifying the meeting audio recording corresponding to the sub-content; and
displaying at least one data display region in the meeting summary, wherein the data display region is configured to display the display data of which the time corresponding to the time of the meeting audio recording.

6. The method according to claim 1, wherein the display data comprises one or more of a screen-recording video and a screenshot image captured by the intelligent meeting interaction device during the target meeting.

7. The method according to claim 5, wherein the quantity of the data display regions is multiple, each data display region corresponds to one sub-content, and the data display region is configured to play a screen-recording video corresponding to the sub-content or display a screenshot image corresponding to the sub-content.

8. The method according to claim 5, wherein after parsing the meeting record file to generate the meeting summary of the target meeting, the method further comprises:
receiving a control request for a target control identifier among audio play control identifiers;
playing a target meeting audio recording corresponding to the target control identifier according to the control request; and
synchronously displaying the display data in the data display region according to a correspondence between the time of the display data and a time of the target meeting audio recording.

9. The method according to claim 6, wherein the display data comprises a screenshot image at an end time of a speaking time of a corresponding speaking object in the meeting audio recording or at a preset time after the speaking time is ended.

10. The method according to claim 6, wherein the display data comprises the screen-recording video, and extracting the meeting record file of the target meeting according to the generation request comprises:
determining a speaking time of each speaking object according to a recognition result of the speaking object in the meeting audio recording; and
determining the screen-recording video corresponding to the speaking time according to the speaking time.

11. The method according to claim 9, wherein the display data comprises display data of an operation region determined according to the speaking time.

12. The method according to claim 11, further comprising: obtaining the display data of the operation region determined according to the speaking time;
wherein obtaining the display data of the operation region determined according to the speaking time comprises:
determining a target operation record corresponding to the speaking time;
identifying an operation region corresponding to a position where the target operation record is located; and
determining the display data corresponding to the speaking time according to the operation region corresponding to the position where the target operation record is located.

13. The method according to claim 12, wherein the target operation record comprises an operation record of a writing operation.

14. The method according to claim 10, wherein determining the screen-recording video corresponding to the speaking time according to the speaking time comprises:
determining an operation time corresponding to the speaking time, wherein the operation time covers the speaking time;
determining the screen-recording video corresponding to the speaking time according to the operation time.

15. The method according to claim 14, wherein the operation time comprises the speaking time, and the operation time further comprises at least one of a first time period or a second time period, wherein the first time period is a time period of a first preset duration before the speaking time, and the second time period is a time period of a second preset duration after the speaking time.

16. The method according to claim 1, wherein the meeting record file further comprises a live video file of the target meeting, and the meeting summary further comprises a live video clip corresponding in time to the meeting audio recording.

17. The method according to claim 1, wherein a format of the meeting record file and/or the meeting summary is an hyper text markup language html format.

18. (canceled)

19. An electronic device comprising: a memory, a processor, and a program stored on the memory and executable on the processor, wherein the processor is configured to read the program in the memory to implement:
receiving a generation request for generating a meeting summary of a target meeting;
extracting a meeting record file of the target meeting according to the generation request, wherein the meeting record file comprises a meeting audio recording and display data, and the meeting audio recording and the display data are collected through an intelligent meeting interaction device; and
parsing the meeting record file to generate the meeting summary of the target meeting, wherein the meeting summary comprises a spoken text generated according to the meeting audio recording and the display data, and a time of the display data corresponds to a time of the meeting audio recording.

20. The electronic device according to claim 19, wherein the electronic device is the intelligent meeting interaction device, the intelligent meeting interaction device comprises a microphone, and the microphone is configured to capture the meeting audio recording.

21. A readable storage medium having a program stored thereon, wherein the program, when executed by a processor, implements:
receiving a generation request for generating a meeting summary of a target meeting;
extracting a meeting record file of the target meeting according to the generation request, wherein the meeting record file comprises a meeting audio recording and display data, and the meeting audio recording and the display data are collected through an intelligent meeting interaction device; and
parsing the meeting record file to generate the meeting summary of the target meeting, wherein the meeting summary comprises a spoken text generated according to the meeting audio recording and the display data, and a time of the display data corresponds to a time of the meeting audio recording.
